(19) United States
(12) Patent Application Publication
(10) Pub. No.: US 2013/0093720 A1
(43) Pub. Date: Apr. 18, 2013

(54) METHOD FOR DETERMINING TOUCH POSITION OF A TOUCH PANEL

(71) Applicants: Tzu-Wei Liu, Hsin-Chu (TW); Hsueh-Ying Huang, Hsin-Chu (TW)

(72) Inventors: Tzu-Wei Liu, Hsin-Chu (TW); Hsueh-Ying Huang, Hsin-Chu (TW)

(73) Assignee: AU OPTRONICS CORP., Hsin-Chu (TW)

(21) Appl. No.: 13/610,824

(22) Filed: Sep. 11, 2012

(30) Foreign Application Priority Data
Oct. 14, 2011 (TW) 100137276

(51) Int. Cl. G06F 3/044; G06F 3/042; G06F 3/041

(52) U.S. Cl. 345/174; 345/173; 345/175

(57) ABSTRACT

A method for determining touch position of a touch panel, which includes reading a voltage signal of a first sensing unit through a readout line in a first time slot of a frame period; reading a voltage signal of a second sensing unit through the readout line in a second time slot of the frame period; generating a difference by subtracting the voltage signal of the second sensing unit from the voltage signal of the first sensing unit, and determining whether the first sensing unit and the second sensing unit are touched according to the difference.

### BACKGROUND OF THE INVENTION

1. Field of the Invention

The present invention relates to a method for determining a touch position of a touch panel, and more particularly, to a method for determining a touch position of a touch panel according to subtraction between voltage signals.

2. Description of the Prior Art

Please refer to FIG. 1. FIG. 1 is a diagram showing a touch panel 100 of the prior art. The touch panel 100 comprises a plurality of pixels P arranged in a matrix form, a plurality of data lines D for transmitting display data to the plurality of pixels P, a plurality of scan lines G for transmitting scan signals to the plurality of pixels P, a common voltage source 110 for providing a common voltage to the plurality of pixels P, a polarity control unit 120 for controlling polarities of the plurality of pixels P, a plurality of sensing units S for generating voltage signals according to external inputs, a plurality of readout lines R, each of the readout lines R being electrically connected to the sensing units S on a corresponding column, and a determining unit 130 for reading voltage signals of the sensing units S through the readout lines R and determining whether the pixels P corresponding to the sensing units S are touched. When the touch panel 100 is touched, the sensing unit S at a touched position generates a different voltage signal according to the external input, such that the touched position of the touch panel 100 can be determined according to voltage levels of the voltage signals of the sensing units S.

Please refer to FIG. 2. FIG. 2 is a diagram showing waveforms of related signals of the touch panel 100. When the pixel P of the touch panel 100 is turned on by a scan signal Y, a noise signal N on the turned on pixel P is generated by the common voltage of the touch panel 100, and the noise signal N of the common voltage may affect touch sensing of the touch panel 100, especially when the determining unit 130 is reading the voltage signal of the sensing unit S corresponding to the turned on pixel P, the voltage signal of the sensing unit S is changed by the noise signal N of the common voltage, and further cause the reading unit 120 to misjudge.

Please refer to FIG. 3. FIG. 3 is a diagram showing another touch panel 200 of the prior art. The touch panel 200 utilizes a difference operator 140 for reducing interference from the noise signal N of the common voltage. For example, the difference operator 140 is electrically connected to the plurality of readout lines R. When the determining unit 130 reads the voltage signal of the sensing unit S11 corresponding to the pixel P11, the difference operator 140 subtracts the voltage signal of the sensing unit S12 at the same row on another readout line R2 from the voltage signal of the sensing unit S11 corresponding to the pixel P11, so as to eliminate the noise signal N of the common voltage. Therefore, the determining unit 130 can read the voltage signal without interference from the noise signal N of the common voltage.

However, the polarity control unit 120 of the touch panel controls the touch panel to display images according to a specific polarity inversion method (such as a dot inversion method, a plural-dot inversion method, or a column inversion method), which means polarities of pixels Pat different positions may be different. When the polarities of two pixels P are different, the method of the prior art may magnify the noise signal N of the common voltage due to subtraction between the voltage signals of the sensing units S on different readout lines R.

### SUMMARY OF THE INVENTION

The present invention provides a method for determining touch position of a touch panel, which comprises reading a voltage signal of a first sensing unit through a readout line in a first time slot of a frame period; reading a voltage signal of a second sensing unit through the readout line in a second time slot of the frame period; generating a difference by subtracting the voltage signal of the second sensing unit from the voltage signal of the first sensing unit, and determining whether the first sensing unit and the second sensing unit are touched according to the difference.

The present invention further provides a touch panel, which comprises a plurality of pixels arranged in a matrix form, a plurality of data lines for transmitting display data to the plurality of pixels, a plurality of scan lines for transmitting scan signals to the plurality of pixels, a plurality of sensing units for generating voltage signals according to external inputs, a plurality of readout lines, each of the readout lines being electrically connected to the sensing units on a corresponding column, a difference operator, and a determining unit. The difference operator is for reading a voltage signal of a first sensing unit through the readout line in a first time slot of a frame period; reading a voltage signal of a second sensing unit through the readout line in a second time slot of the frame period; and generating a difference by subtracting the voltage signal of the second sensing unit from the voltage signal of the first sensing unit. The determining unit is for determining whether the first sensing unit and the second sensing unit are touched according to the difference.

The present invention further provides a touch panel, which comprises a plurality of pixels arranged in a matrix form, a plurality of data lines for transmitting display data to the plurality of pixels, a plurality of scan lines for transmitting scan signals to the plurality of pixels, a plurality of sensing units for generating voltage signals according to external inputs, a plurality of readout lines, each of the readout lines being electrically connected to the sensing units on a corresponding column, a plurality of difference operators, and a determining unit. Each of the difference operators is electrically connected to one of the readout lines for reading a voltage signal of a first sensing unit through the readout line in a first time slot of a frame period; reading a voltage signal of a second sensing unit through the readout line in a second time slot of the frame period; and generating a difference by subtracting the voltage signal of the second sensing unit from the voltage signal of the first sensing unit. The determining unit is for determining whether the first sensing unit and the second sensing unit are touched according to the difference.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a touch panel of the prior art.

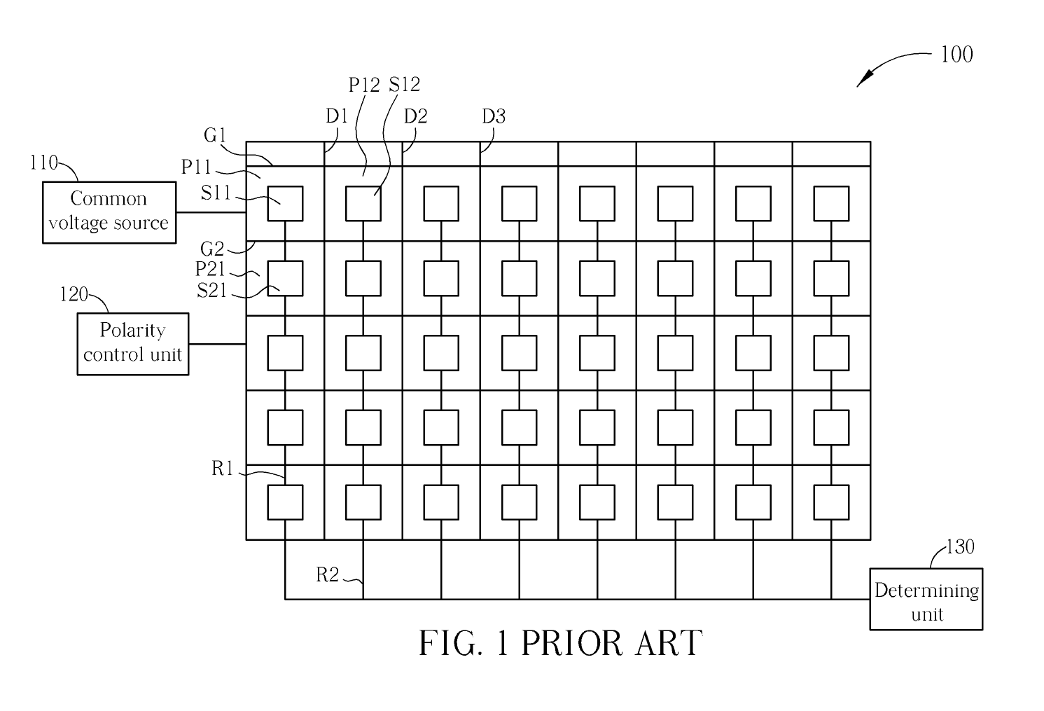

FIG. 2 is a diagram showing waveforms of related signals of the touch panel.

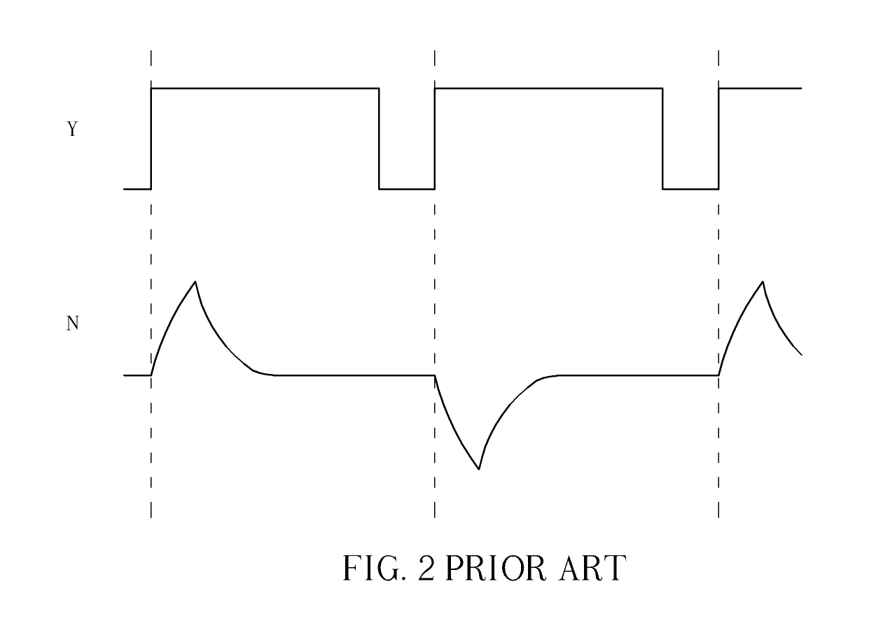

FIG. 3 is a diagram showing another touch panel of the prior art.

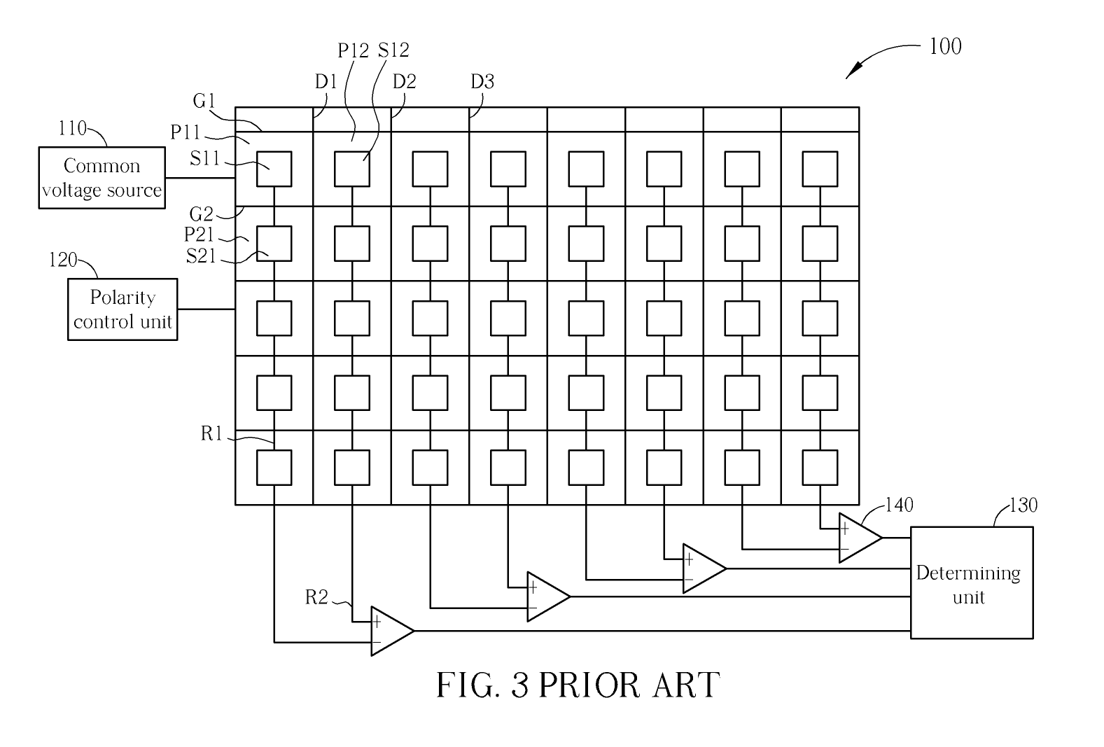

FIG. 4 is a diagram showing a first embodiment of a touch panel of the present invention.

FIG. 5 is a diagram showing a difference operator of FIG. 4.

FIG. 6 is a diagram showing a second embodiment of the touch panel of the present invention.

FIG. 7 is a flowchart showing the method for determining the touch position of the touch panel of the present invention.

FIG. 8 is a diagram showing a third embodiment of the touch panel of the present invention.

FIG. 9 is a diagram showing a fourth embodiment of the touch panel of the present invention.

FIG. 10 is a diagram showing a fifth embodiment of the touch panel of the present invention.

### DETAILED DESCRIPTION

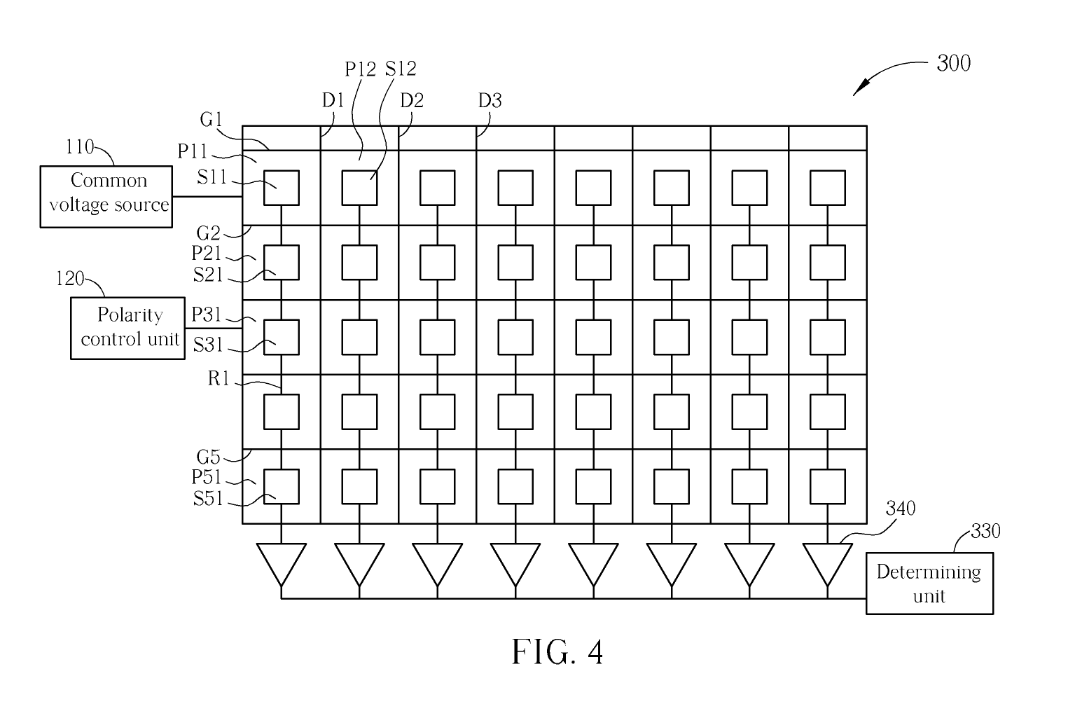

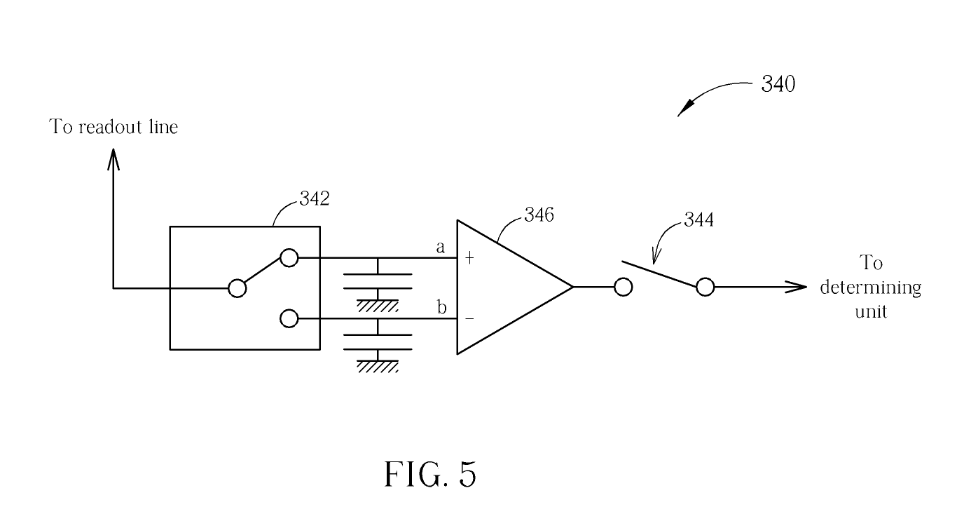

Please refer to FIG. 4 and FIG. 5. FIG. 4 is a diagram showing a first embodiment of a touch panel of the present invention. FIG. 5 is a diagram showing a difference operator of FIG. 4. The touch panel 300 of the present invention comprises a plurality of pixels P arranged in a matrix form, a plurality of data lines D for transmitting display data to the plurality of pixels P, a plurality of scan lines G for transmitting scan signals to the plurality of pixels P, a common voltage source 110 for providing a common voltage to the plurality of pixels P, a polarity control unit 120 for controlling polarities of the plurality of pixels P, a plurality of sensing units S for generating voltage signals according to external inputs, a plurality of readout lines R, each of the readout lines R being electrically connected to the sensing units S on a corresponding column, a plurality of difference operator 340, and a determining unit 330.

Different from the prior art, the difference operator 340 is utilized for subtracting voltage signals between sensing units S corresponding to the pixels P with same polarity on the readout line R according to a polarity inversion method of the touch panel 300, so as to eliminate the noise signal of the common voltage. For example, when the touch panel 300 is driven by the dot inversion method to display images, the polarity of the pixel P11 on a first row of the readout line R1 is equal to the polarity of the pixels P31 and P51 on third and fifth rows of the readout line R1 in a same frame period. Thus, in the same frame period, the difference operator 340 can read the voltage signal of the sensing unit S11 corresponding to the pixel P11 on the first row of the readout line R1 when the pixel P11 is turned on (the selector 342 is electrically connected to a first input end a of a difference generator 346, and a switch 344 at an output end of the difference generator 346 is turned off), and then reads the voltage signal of the sensing unit S31 corresponding to the pixel P31 on the third row of the readout line R1 when the pixel P31 is turned on (the selector 342 is electrically connected to a second input end b of the difference generator 346, and the switch 344 at the output end of the difference generator 346 is turned off). Thereafter, a difference is generated by subtracting the voltage signal of the sensing unit S31 from the voltage signal of the sensing unit S31, and transmitted to the determining unit 330 (the switch 344 at the output end of the difference generator 346 is turned on). The determining unit 330 further determines whether the pixel P11 and the pixel P31 are touched according to the difference. For example, if the touch panel 300 is a photo type touch panel, when the pixel P31 on the third row of the readout line R1 is touched, the voltage signal of the sensing unit S31 corresponding to the pixel P31 on the third row of the readout line R1 has a lower voltage level, such that the difference is a positive value; when the pixel P11 on the first row of the readout line R1 is touched, the voltage signal of the sensing unit S11 corresponding to the pixel P31 on the first row of the readout line R1 has a lower voltage level, such that the difference is a negative value; and when neither the pixel P11 on the first row of the readout line R1 nor the pixel P31 on the third row of the readout line R1 is touched, the difference is close to zero.

According to the above arrangement, the determining unit 330 can correctly determine whether the pixel is touch without being interfered by the noise signal of the common voltage.

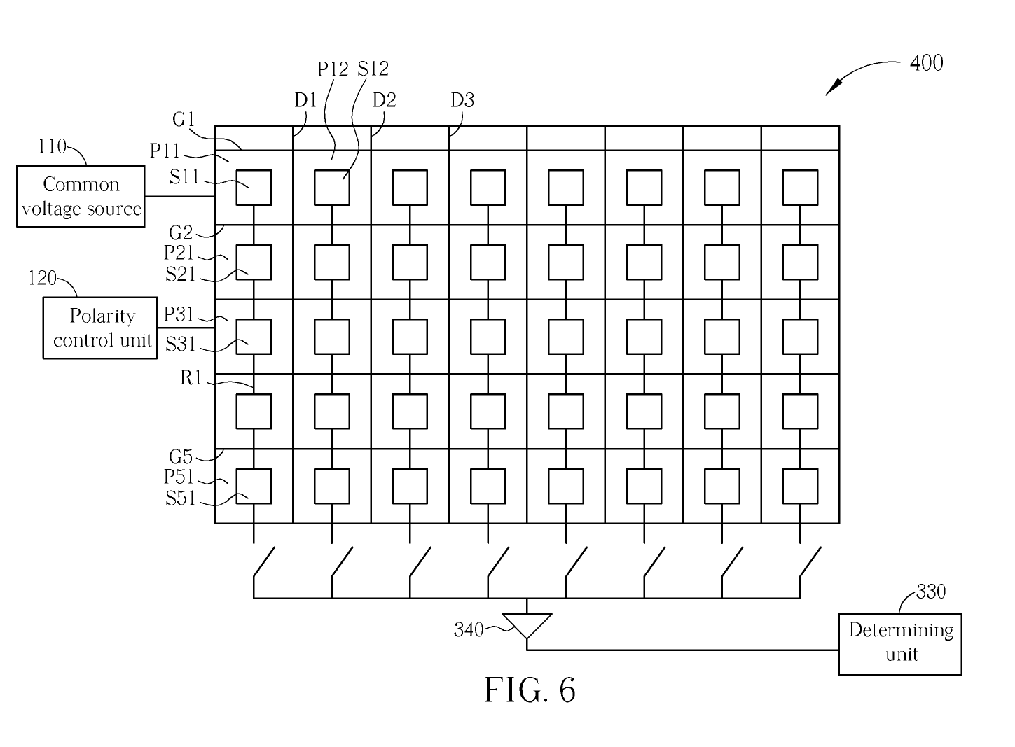

Please refer to FIG. 6. FIG. 6 is a diagram showing a second embodiment of the touch panel of the present invention. The touch panel 400 can only comprise one difference operator 340 for selectively subtracting voltage signals between the sensing units corresponding to the targeted pixels through the plurality of the readout lines R.

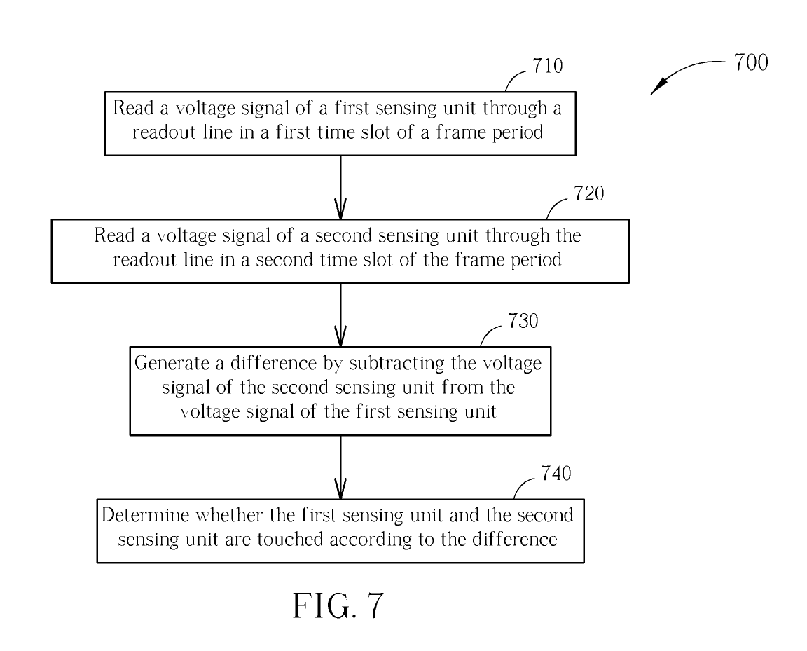

Pease refer to FIG. 7. FIG. 7 is a flowchart 700 showing the method for determining the touch position of the touch panel of the present invention. The method for determining the touch position of the touch panel of the present invention comprises the following steps:

Step 710: Read a voltage signal of a first sensing unit through a readout line in a first time slot of a frame period;

Step 720: Read a voltage signal of a second sensing unit through the readout line in a second time slot of the frame period;

Step 730: Generate a difference by subtracting the voltage signal of the second sensing unit from the voltage signal of the first sensing unit; and

Step 740: Determine whether the first sensing unit and the second sensing unit are touched according to the difference.

Basically, the steps of the flowchart 700 need not be in the exact order shown and need not be contiguous, that is, other steps can be inserted between, such as a step of driving the touch panel according to a polarity inversion method. The polarity inversion method can be a dot inversion method, a plural-dot inversion method, or a column inversion method.

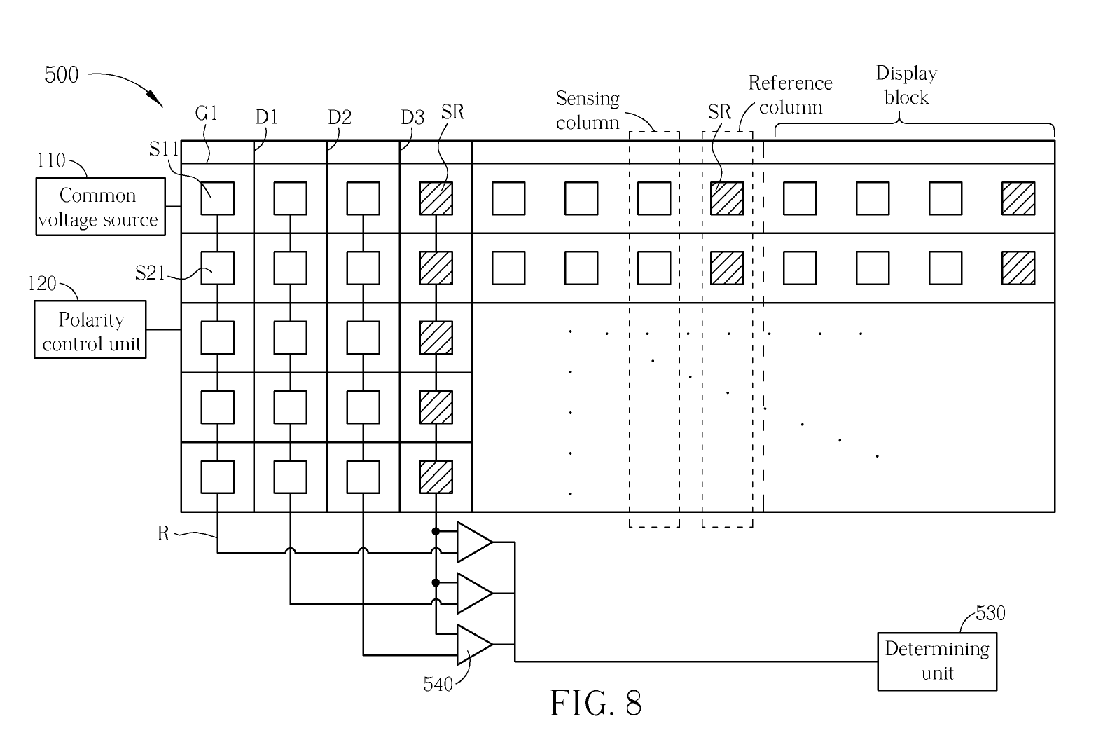

Please refer to FIG. 8. FIG. 8 is a diagram showing a third embodiment of the touch panel of the present invention. As shown in FIG. 8, the touch panel 500 is divided into a plurality of display blocks. Each of the display blocks comprises a plurality of pixels P arranged in a matrix form, a plurality of sensing units S, and a plurality of reference units SR. The plurality of sensing units S are arranged on a plurality of sensing columns for generating voltage signals according to external inputs. The plurality of reference units SR are arranged on a reference column for generating reference voltage signals. The difference operator 540 is for generating a difference by subtracting a reference voltage signal of a reference unit SR on a row from a voltage signal of one of the plurality of sensing units on the same row through the readout lines R when the pixels on the row are turned on. The determining unit 530 then determines whether the pixel on the row is touched according to the difference. According to the above arrangement, the touch panel 500 determines whether the pixel P corresponding to the sensing unit S is touched according to the reference voltage signal of the reference unit SR, such that the interference from the noise signal of the common voltage can be avoided.

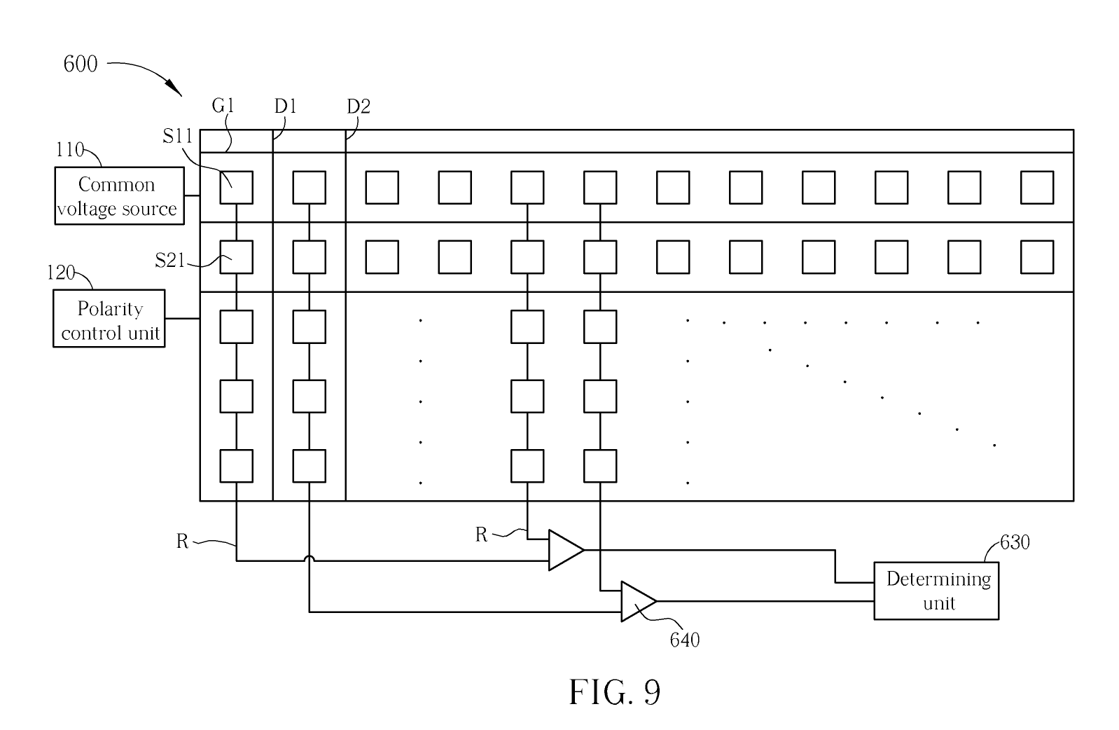

Please refer to FIG. 9. FIG. 9 is a diagram showing a fourth embodiment of the touch panel of the present invention. As shown in FIG. 9, each of the difference operators 640 is electrically connected to two of the readout lines R a predetermined columns (such as three columns) away from each other for generating a difference by subtracting a voltage signal of the sensing unit on a row from a voltage signal of the other sensing units on the row through the two readout lines R when the pixels P on the row are turned on. The determining unit 630 then determines whether the pixels P on the row are touched according to the difference. According to the above arrangement, the two sensing units S are separated from each other a certain distance, such that it can prevent that the two sensing units are touched at the same time due to being close to each other, which may cause the determining unit 630 to misjudge.

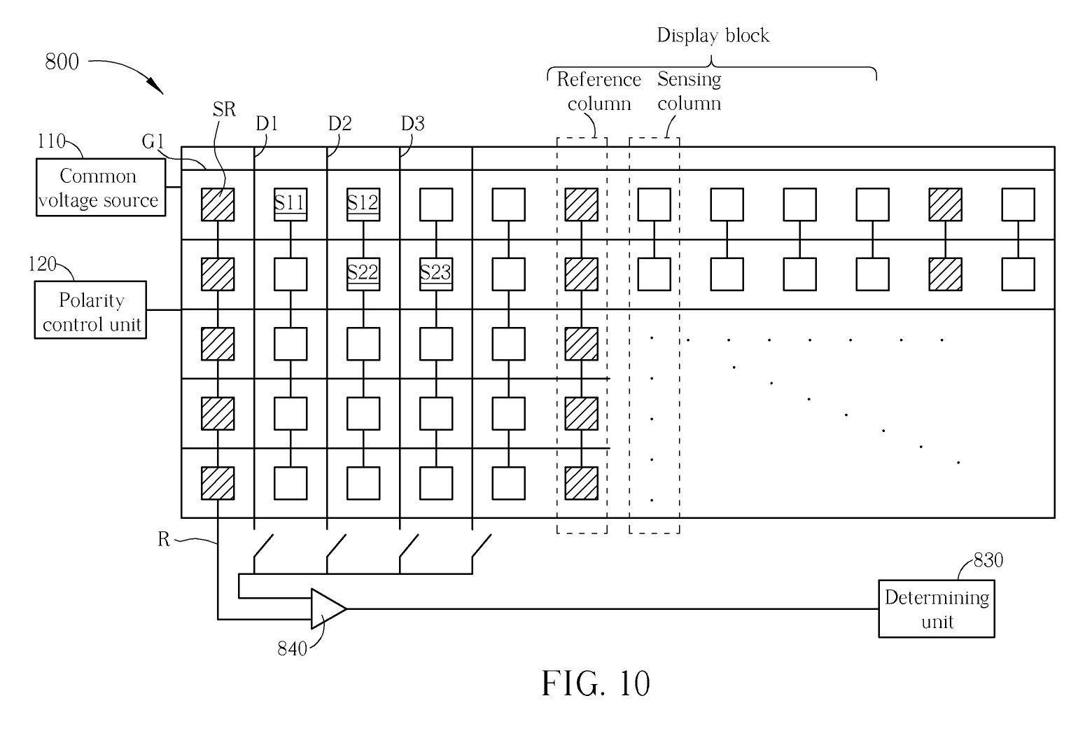

Please refer to FIG. 10. FIG. 10 is a diagram showing a fifth embodiment of the touch panel of the present invention. The touch panel 800 is divided into a plurality of display blocks. Each of the display blocks comprises a plurality of pixels P arranged in a matrix form, a plurality of sensing units S, and a plurality of reference units SR. The plurality of sensing units S are arranged on a plurality of sensing columns for generating voltage signals according to external inputs. The plurality of reference units SR are arranged on a reference column for generating reference voltage signals. Each of the difference operators 840 is electrically connected to one of the display blocks for reading a voltage signal of a corresponding sensing unit S and a reference signal of a corresponding reference unit SR through the readout lines R according to a predetermined time sequence. For example, difference operators 840 generates a first difference by subtracting the reference voltage signal of the reference unit SR on the first row from the voltage signal of the sensing unit S11 on the first column and the first row through the readout lines R in a first time slot of a first frame period (when the pixels on the first row are turned on). The determining unit 830 then generates a second difference by subtracting the reference voltage signal of the reference unit SR on the second row from the voltage signal of the sensing unit S22 on second column and the second row through the readout lines R in a second time slot of the first frame period (when the pixels on the second row are turned on). The determining unit 830 then determines whether the pixels P on the first and second rows are touched according to the first difference and the second difference. In a second frame period, the difference operator 840 further generates a third difference by subtracting the reference voltage signal of the reference unit SR on the first row from the voltage signal of the sensing unit S12 on the second column and the first row through the readout lines R in a first time slot of the second frame period (when the pixels on the first row are turned on). The determining unit 830 further generates a fourth difference by subtracting the reference voltage signal of the reference unit SR on the second row from the voltage signal of the sensing unit S23 on a third column and the second row through the readout lines R in a second time slot of the second frame period (when the pixels on the second row are turned on). The determining unit then determines whether the pixels on the first and second rows are touched according to the third difference and the fourth difference. According to the above arrangement, the difference operator 840 reads the voltage signal of the corresponding sensing unit S and the reference signal of the corresponding reference unit SR through the readout lines R according to the predetermined time sequence, such that it can prevent that multiple sensing units S are touched at the same time, which may cause the determining unit 830 to misjudge.

In addition, the above touch panel can be a photo type touch panel or a capacitive type touch panel.

In contrast to the prior art, the touch panel of the present invention can eliminate the noise signal of the common voltage by subtracting voltage signals between the sensing units corresponding to the pixels with the same polarity on a same readout line according to the polarity inversion method of the touch panel, such that the determining unit can correctly determine whether the pixel is touched without magnifying the noise signal of the common voltage.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for determining touch position of a touch panel, comprising:
reading a voltage signal of a first sensing unit through a readout line in a first time slot of a frame period;
reading a voltage signal of a second sensing unit through the readout line in a second time slot of the frame period;
generating a difference by subtracting the voltage signal of the second sensing unit from the voltage signal of the first sensing unit, and
determining whether the first sensing unit and the second sensing unit are touched according to the difference.

2. The method of claim 1, wherein the first sensing unit corresponds to a first pixel, the second sensing unit corresponds to a second pixel, and polarity of the second pixel is identical to polarity of the first pixel.

3. The method of claim 2 further comprising driving the touch panel according to a polarity inversion method.

4. The method of claim 3, wherein the polarity inversion method is a dot inversion method, a plural-dot inversion method, or a column inversion method.

5. The method of claim 2 further comprising providing a common voltage to the first pixel and the second pixel.

6. A touch panel, comprising:
a plurality of pixels arranged in a matrix form;
a plurality of data lines for transmitting display data to the plurality of pixels;
a plurality of scan lines for transmitting scan signals to the plurality of pixels;
a plurality of sensing units for generating voltage signals according to external inputs;
a plurality of readout lines, each of the readout lines being electrically connected to the sensing units on a corresponding column;
a difference operator for reading a voltage signal of a first sensing unit through the readout line in a first time slot of a frame period; reading a voltage signal of a second sensing unit through the readout line in a second time slot of the frame period; and generating a difference by subtracting the voltage signal of the second sensing unit from the voltage signal of the first sensing unit; and
a determining unit for determining whether the first sensing unit and the second sensing unit are touched according to the difference.

7. The touch panel of claim 6, wherein the first sensing unit corresponds to a first pixel, the second sensing unit corresponds to a second pixel, and polarity of the second pixel is identical to polarity of the first pixel.

8. The touch panel of claim 6 being a photo type touch panel.

9. The touch panel of claim 6 being a capacitive type touch panel.

10. The touch panel of claim 6 further comprising a polarity control unit for controlling polarities of the plurality of pixels.

11. The touch panel of claim 6 further comprising a common voltage source for providing a common voltage to the plurality of pixels.

12. A touch panel, comprising:
a plurality of pixels arranged in a matrix form;
a plurality of data lines for transmitting display data to the plurality of pixels;
a plurality of scan lines for transmitting scan signals to the plurality of pixels;
a plurality of sensing units for generating voltage signals according to external inputs;
a plurality of readout lines, each of the readout lines being electrically connected to the sensing units on a corresponding column;
a plurality of difference operators, each of the difference operators being electrically connected to one of the readout lines for reading a voltage signal of a first sensing unit through the readout line in a first time slot of a frame period; reading a voltage signal of a second sensing unit through the readout line in a second time slot of the frame period; and generating a difference by subtracting the voltage signal of the second sensing unit from the voltage signal of the first sensing unit; and
a determining unit for determining whether the first sensing unit and the second sensing unit are touched according to the difference.

13. The touch panel of claim 12, wherein the first sensing unit corresponds to a first pixel, the second sensing unit corresponds to a second pixel, and polarity of the second pixel is identical to polarity of the first pixel.

14. The touch panel of claim 12 being a photo type touch panel.

15. The touch panel of claim 12 being a capacitive type touch panel.

16. The touch panel of claim 12 further comprising a polarity control unit for controlling polarities of the plurality of pixels.

17. The touch panel of claim 12 further comprising a common voltage source for providing a common voltage to the plurality of pixels.

18. A touch panel, comprising:
a plurality of display blocks, each of the display blocks comprising:
a plurality of pixels arranged in a matrix form;
a plurality of sensing units arranged on a plurality of sensing columns for generating voltage signals according to external inputs; and
a plurality of reference units arranged on a reference column for generating reference voltage signals;
a plurality of data lines for transmitting display data to the plurality of pixels;
a plurality of scan lines for transmitting scan signals to the plurality of pixels;
a plurality of readout lines, each of the readout lines being electrically connected to the sensing units or the reference units on a corresponding column;
a plurality of difference operators, each of the difference operators being for generating a difference by subtracting the reference voltage signal of the reference unit on a row from a voltage signal of one of the plurality of sensing units on the row through the readout lines; and
a determining unit for determining whether the sensing unit on the row is touched according to the difference.

19. The touch panel of claim 18 being a photo type touch panel.

20. The touch panel of claim 18 being a capacitive type touch panel.

21. A touch panel, comprising:
a plurality of pixels arranged in a matrix form;
a plurality of data lines for transmitting display data to the plurality of pixels;
a plurality of scan lines for transmitting scan signals to the plurality of pixels;
a plurality of sensing units for generating voltage signals according to external inputs;
a plurality of readout lines, each of the readout lines being electrically connected to the sensing units on a corresponding column;
a plurality of difference operators, each of the difference operators being electrically connected to two of the readout lines a predetermined amount of columns away from each other for generating a difference by subtracting a voltage signal of the sensing unit on a row from a voltage signal of the other sensing units on the row through the two readout lines; and
a determining unit for determining whether the sensing unit on the row is touched according to the difference.

22. The touch panel of claim 21, wherein the predetermined amount is equal to or more than one.

23. The touch panel of claim 21 being a photo type touch panel.

24. The touch panel of claim 21 being a capacitive type touch panel.

25. A touch panel, comprising:
a plurality of display blocks, each of the display blocks comprising:
a plurality of pixels arranged in a matrix form;
a plurality of sensing units arranged on a plurality of sensing columns for generating voltage signals according to external inputs; and
a plurality of reference units arranged on a reference column for generating reference voltage signals;
a plurality of data lines for transmitting display data to the plurality of pixels;
a plurality of scan lines for transmitting scan signals to the plurality of pixels;
a plurality of readout lines, each of the readout lines being electrically connected to the sensing units or the reference units on a corresponding column;
a plurality of difference operators, each of the difference operators being electrically connected to one of the display blocks for generating a first difference by subtracting the reference voltage signal of the reference unit on a Yth row from the voltage signal of the sensing unit on an Xth column and the Yth row through the readout lines in a first time slot of a first frame period, and generating a second difference by subtracting the reference voltage signal of the reference unit on a (Y+1)th row from the voltage signal of the sensing unit on a (X+1)th column and the (Y+1)th row through the readout lines in a second time slot of the first frame period; and
a determining unit for determining whether the sensing units on the Yth and (Y+1)th rows are touched according to the first difference and the second difference respectively.

26. The touch panel of claim 25, wherein the difference operator is further configured for generating a third difference by subtracting the reference voltage signal of the reference unit on the Yth row from the voltage signal of the sensing unit on a (X+1)th column and the Yth row through the readout lines in a first time slot of a second frame period, and generating a fourth difference by subtracting the reference voltage signal of the reference unit on the (Y+1) th row from the voltage signal of the sensing unit on a (X+2)th column and the (Y+1)th row through the readout lines in a second time slot of the second frame period; and
wherein the determining unit is further configured for determining whether the sensing units on the Yth and (Y+1)th rows are touched according to the third difference and the fourth difference respectively.

27. The touch panel of claim 25 being a photo type touch panel.

28. The touch panel of claim 25 being a capacitive type touch panel.
